(19) United States
(12) Patent Application Publication
(10) Pub. No.: US 2009/0071449 A1
(43) Pub. Date: Mar. 19, 2009

(54) MULTI-PURPOSE LIQUID ATOMIZER UTILIZING CATALYST, TURBULENCE, AND COLLISION

(76) Inventor: Bong kyu Choi, Inchon (KR)

Correspondence Address: HUGHES LAW FIRM, PLLC, PACIFIC MERIDIAN PLAZA, SUITE 302, 4164 MERIDIAN STREET, BELLINGHAM, WA, 98226-5583, US

(21) Appl. No.: 11/719,237

(22) PCT Filed: May 27, 2005
(86) PCT No.: PCT/KR05/01561

§ 371 Date: May 14, 2007

(30) Foreign Application Priority Data
Nov. 12, 2004 (KR) 10-2004-0092407

(51) Int. Cl. F02M 27/04

(52) U.S. Cl. 123/538

(57) ABSTRACT

The present invention relates to a multi-purpose liquid atomizer utilizing a catalyst, turbulence, and collision. More specifically, the present invention relates to a multi-purpose liquid atomizer using a catalyst, turbulence, and collision, involving forming ceramic serving as a catalyst in inlet and outlet caps, such that the liquid fuel can be reformed into a liquid fuel satisfying a maximized contact area with air or oxygen for effective combustion of the liquid fuel, thereby promoting combustion reaction and remarkably enhanced surface area by liquid atomization; packing ceramic fillers into a central part of a main body; forming an uneven number of flow holes for liquid fuel by which the liquid fuel can be reformed while flowing along inside passages of the main body for an adequate period of time; furnishing mortar-shaped special metal springs within the flow holes such that the liquid fuel can be whirled and collided; and arranging specially-designed plural rows of permanent magnets along the outer circumference of the main body such that the liquid fuel can be reformed. As such, the multi-purpose liquid atomizer in accordance with the present invention provides effects such as improved heat efficiency of the liquid carbon fuel leading to reduction of fuel consumption, clarification, and induction of a fuel system leading to reduction in discharged exhaust gas, and supply of clean, potable water necessary, by ionization of water molecules.

### RELATED APPLICATIONS

This application claims priority of Korean Serial No. 10-2004-0092407 filed Nov. 12, 2004, and PCT/KR2005/001561, filed May 27, 2005.

### TECHNICAL FIELD

The present invention relates to a multi-purpose liquid atomizer utilizing a catalyst, turbulence, and collision. More specifically, the present invention relates to a multi-purpose liquid atomizer using a catalyst, turbulence, and collision, involving forming ceramic serving as a catalyst in inlet and outlet caps, such that the liquid fuel can be reformed into a liquid fuel satisfying a maximized contact area with air or oxygen for effective combustion of the liquid fuel, thereby promoting combustion reaction and remarkably enhanced surface area by liquid atomization; packing ceramic fillers into a central part of a main body; forming an uneven number of flow holes for liquid fuel by which the liquid fuel can be reformed while flowing along inside passages of the main body for an adequate period of time; furnishing mortar-shaped special metal springs within the flow holes such that the liquid fuel can be whirled and collided; and arranging specially-designed plural rows of permanent magnets along the outer circumference of the main body such that the liquid fuel can be reformed. As such, the multi-purpose liquid atomizer in accordance with the present invention provides effects such as improved heat efficiency of the liquid carbon fuel leading to reduction of fuel consumption, clarification, and induction of a fuel system leading to reduction in discharged exhaust gas, and supply of clean, potable water, by ionization of water molecules.

### BACKGROUND ART

Conventionally used instruments for reducing fuel consumption and soot and smoke generation have been developed in a variety of forms. Among such instruments, a product taking advantage of magnetic fields induces complete combustion of fuel by atomizing the fuel and enhancing heat conductivity via unipolar magnetization. However, such a product suffers from degradation of magnetizability due to high temperatures generated within an engine thus leading to incomplete combustion upon prolonged use.

In addition, conventional products have achieved complete combustion by passing the fuel through fine screws thereby resulting in induction of ion activation, using magnetic-reaction principles. However, this technique has disadvantages such as insufficient reaction effects due to instantaneous passage of the fuel through fine screws, and sticking of impurities contained in the fuel to the inside of the product during passage of the fuel, thereby resulting in failure of fuel supply to the engine leading to engine troubles upon prolonged use.

In order to solve the above-mentioned problems, granted Korean Patent Registration No. 142887 discloses a fuel catalyzer made up of magnets, a diode and a composite material having combined advantages of two different materials utilized such as abrasion resistance and metal properties, for example ductility, malleability, and thermal conductivity obtained by binding ceramic particles to transition metals. In this technique, static electricity generated due to flow and vibration of fuel in a fuel tank during operation of a vehicle acts via a tank inner wall on the diode to generate electron ions, and far-infrared waves and magnetic waves, generated from a composite far-infrared material, alter bonds in the molecular structure of the liquid fuel gas charged in the fuel tank, thereby achieving an enhanced combustion rate of the fuel. However, this type of fuel catalyzer is installed inside the fuel tank and thus suffers from problems associated with failure to reform the total fuel charged in the fuel tank, and lowered efficiency due to fuel reforming via use of far-infrared waves and magnetic waves alone.

### DISCLOSURE

### Technical Problem

Therefore, the present invention has been made in view of the above problems, and it is an object of the present invention to provide a multi-purpose liquid atomizer having improved combustion efficiency, reduced fuel consumption, and, at the same time, a clarified fuel system leading to reduction of exhaust gas via liquid atomization capable of saving energy and reducing exhaust gas by use of a catalyst, and turbulence and collision phenomena.

It is another object of the present invention to provide a multi-purpose liquid atomizer for providing potable ionized water via reforming of water molecules utilizing a catalyst and turbulence and collision phenomenon.

In accordance with the present invention, the above and other objects can be accomplished by the provision of a multi-purpose liquid atomizer, utilizing a catalyst, turbulence, and collision, comprising: a cylindrical main body having inlet/outlet grooves for flow of liquid fuel and cylindrical ceramic filling grooves containing powdered ceramic fillers packed therein, formed in multiple stages, at the central outer surface of both sides thereof, circular-shaped magnetic plates for supplying far-infrared radiation and sealing the ceramic fillers formed at the end of the ceramic filling grooves, an uneven number of flow holes radially formed around the ceramic filling grooves so as to penetrate through the main body, inlet/outlet passages communicating between inlet/outlet grooves and different flow holes formed in the main body, flow passages communicating two different flow holes formed at both sides of the main body, an even number of permanent magnets for reforming liquid fuel, formed in plural rows between flow holes along the outer surface of the main body, circular-shaped sealing plates having through holes at the centers thereof, and sealing flow holes and flow passages formed at both sides of the main body, and inlet/outlet caps fixing the sealing plates to both sides of the main body, containing a multiplicity of ceramic balls catalyzing the liquid fuel formed therein and having a turbulence plate generating turbulence formed on the central inner side; wherein centrally concave mortar-shaped circular special metal springs are formed within the flow holes to cause turbulence and collision of the liquid fuel, and a [symbol] shaped turbulence hole for swirling inflow/outflow of the liquid fuel is formed at center of the turbulence plate.

In addition, the ceramic fillers 4 and ceramic balls 5 may be prepared using a basic component (A) consisting of 61 to 68.5% by weight of SiO₂, 10.1 to 13.4% by weight of Al₂O₃, 1.2 to 3.54% by weight of Fe₂O₂, 1.98 to 2.98% by weight of CaO₂, 0.5 to 1.91% by weight of MgO₂, 2.5 to 4.5% by weight of K₂O, 3.59 to 5% by weight of Na₂O, 1.5 to 2.0% by weight of TiO₂, 0.05 to 1% by weight of ZrO₂, 5.8 to 8.0% by weight of Igloss and 4.28 to 5.5% by weight of Se; and an additional component (B) consisting of 4 to 5% by weight of cupric oxide, 6 to 7% by weight of ZrO₂, 14 to 16% by weight of CaO₂, 7 to 9% by weight of TiO₂, 4 to 7% by weight of cobalt, 6 to 7% by weight of B₂O, 8 to 13% by weight of CeO₂, 5 to 7% by weight of K₂O₃, 4 to 6% by weight of Mo, 5 to 7% by weight of SrO₃, 10 to 25% by weight of CaO, 4 to 5% by weight of MgZn, 5 to 9% by weight of NiZn, and 3 to 5% by weight of Pd. That is, a process for preparing the ceramic fillers is carried out by mixing and sintering 63 to 83% by weight of the basic component (A) and 37 to 17% by weight of the additional component at a temperature of 1000 to 1300° C. and milling the resulting material to a size of 3 to 5 μm, and the ceramic balls are prepared by mixing and sintering 63 to 83% by weight of the basic component (A) and 37 to 17% by weight of the additional component at a temperature of 1000 to 1300° C. and forming the resulting materials into balls.

### Technical Solution

Preferred embodiments of the present invention will now be described in detail with reference to the annexed drawings. FIG. 1 is an exploded perspective view of a liquid atomizer in accordance with the present invention; FIG. 2 is an assembled perspective view of a liquid atomizer in accordance with the present invention; FIG. 3 is a front cross sectional view of a liquid atomizer in accordance with the present invention; FIG. 4 is a side cross sectional view of a liquid atomizer in accordance with the present invention; FIG. 5 is a side view showing a main body of a liquid atomizer in accordance with the present invention; FIG. 6 is a view of the other side showing a main body of a liquid atomizer in accordance with the present invention; and FIG. 7 is an exploded perspective view of a turbulence plate in accordance with the present invention.

The present invention relates to equipment for induction of complete combustion of liquid fuel, by subjecting the liquid fuel to catalytic reaction, turbulence, and collision to achieve effective absorption and diffusion of most suitable far-infrared emissivity of fuel molecules, and by using magnetic induction of anions and cations and electromagnetic principles to cause ion oxidation, reduction, resonance, resonance movement and magnetic-heat generation phenomena, thus weakening binding between particles, leading to enlarged contact area between particles and oxygen molecules and thus increased mixing rate with air.

Referring to FIGS. 1 through 7, the constitution and operation in accordance with one embodiment of the present invention are specifically described as follows. When the liquid fuel is supplied through an inlet/outlet 21 of an inlet/outlet cap 2 formed at one side of a main body 1, the liquid fuel is ion-activated by a turbulence plate 22 having a turbulence hole 221 formed at inner side thereof with a inlet/outlet cap 2 and then catalyzed by far-infrared waves emitted from ceramic balls 5 packed inside. Therefore, the thus-treated liquid fuel is supplied to inlet/outlet grooves 11 through which the liquid fuel enters, via a through hole 31 of the sealing plate 3.

In addition, magnetic plates 6, which seal the packed powdered ceramic fillers 4 and generate a magnetic field force together with far-infrared radiation produced from the ceramic fillers 4, are installed within ceramic packing grooves 12 formed in multiple stages on the inside of the inlet/outlet grooves 11. In order to seal the ceramic fillers 4 more tightly by utilizing the magnetic plates 6, an O-ring 61 or a molding (not shown) may be installed.

In this connection, as shown in FIGS. 1, 5, and 6, flow passages 15, which are formed within the main body 1 and through which the liquid fuel flows, are provided with an uneven number of flow holes 13 that are radially formed so as to penetrate through the main body 1, such that the liquid fuel supplied through inlet/outlet caps 2 continuously passes through flow holes 13 formed on the outer circumference of the main body and then achieves collision with a catalyst and turbulence, by sealing plates 3 provided at both sides of the main body, with two different flow holes 13 being communicated each other by the respective flow passages 15. In addition, inlet/outlet passages 14, which provide communication between inlet/outlet grooves 11 formed at both sides of the main body 1 and different flow holes 13, are formed. Therefore, when inlet/outlet passages 14 are sealed by the sealing plates 3, the liquid fuel introduced to the inlet/outlet grooves 11 flows to first flow holes 13 via the inlet/outlet passages 14, and the liquid fuel flows again into flow holes 13 via flow passages 15 providing communication between two flow holes 13 formed at the other side. Herein, formation of flow passages 15 connecting two different flow holes 13 and formation of inlet/outlet passages 14 in different inlet/outlet grooves 11 are designed to reform the liquid fuel while it passes zigzag along and through flow holes 13.

In order to effect that the liquid fuel supplied to one side of the main body 1 is supplied to the other side, the flow holes 13 should be formed in an uneven number. The number of flow holes 13 may be adjusted in the range of 5 to 15, depending upon the amount of supplied liquid fuel.

As such, the liquid fuel passing through the main body 1 undergoes ionization by collision with turbulence generated through the mortar-shaped springs 7 installed in flow holes 13, while the liquid fuel is reformed to completely combustible liquid fuel by catalytic action of far-infrared radiation emitted from the ceramic fillers 4 formed at the center of the main body 1 and magnetic field effects of permanent magnets 8 arranged in plural rows along the external surface of the main body 1.

Therefore, the even number of permanent magnets 8 arranged in plural rows along the outer surface of the main body 1 are installed between flow holes 13 in order to reform liquid fuel passing through the main body 1, thereby maximizing magnetic field effects.

In addition, the circular-shaped special metal springs 7 installed within the flow holes 13 are preferably formed to have a center concave-mortar shape so as to achieve turbulence and collision of the liquid fuel. Thereby, the liquid fuel flowing through flow holes 13 is more effectively ionized by collision with springs and vibration of the collided springs.

At the center of the turbulence plate 22 shown in FIG. 7, a [symbol] shaped turbulence-generating hole 221 is formed such that inflow/outflow of the liquid fuel is swirled to effect ionization of the liquid fuel, thereby enhancing efficiency of catalytic action.

In the above-mentioned embodiment in accordance with the present invention, for inlets/outlets having the same constitution formed at both sides of the main body 1, a role as the inlet/outlet may be varied depending upon installation state thereof, and working state thereof is also the same. Therefore, details thereof will be omitted.

### ADVANTAGEOUS EFFECTS

As apparent from the above description, the present invention can be widely applied to vehicles and broad industrial field, by reforming liquid fuel or water via use of a catalyst, and turbulence and collision phenomena. In particular, in accordance with the present invention, it is possible to augment combustion efficiency of vehicles, thereby remarkably reducing fuel consumption, and it is also possible to achieve clarification of fuel systems and complete combustion of fuels, thus leading to reduction in an amount of exhaust gas discharged.

Further, the present invention can be utilized in water purifiers and water softeners without requiring filters that are beneficial to the humans, instant hot water heaters, and heating arrangements, by reforming water molecules, i.e., ionization of water

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

### DESCRIPTION OF DRAWINGS

The above and other objects, features and other advantages of the present invention will be more clearly understood from the following detailed description taken in conjunction with the accompanying drawings, in which:

FIG. 1 is an exploded perspective view of a liquid atomizer in accordance with the present invention;

FIG. 2 is an assembled perspective view of a liquid atomizer in accordance with the present invention;

FIG. 3 is a front cross sectional view of a liquid atomizer in accordance with the present invention;

FIG. 4 is a side cross sectional view of a liquid atomizer in accordance with the present invention;

FIG. 5 is a side view showing a main body of a liquid atomizer in accordance with the present invention;

FIG. 6 is a view from the other side showing a main body of a liquid atomizer in accordance with the present invention; and

FIG. 7 is an exploded perspective view of a turbulence plate in accordance with the present invention.

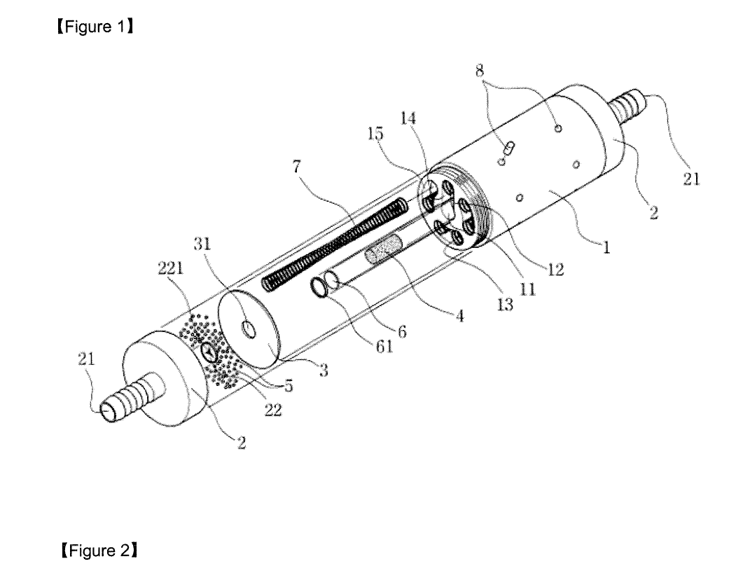

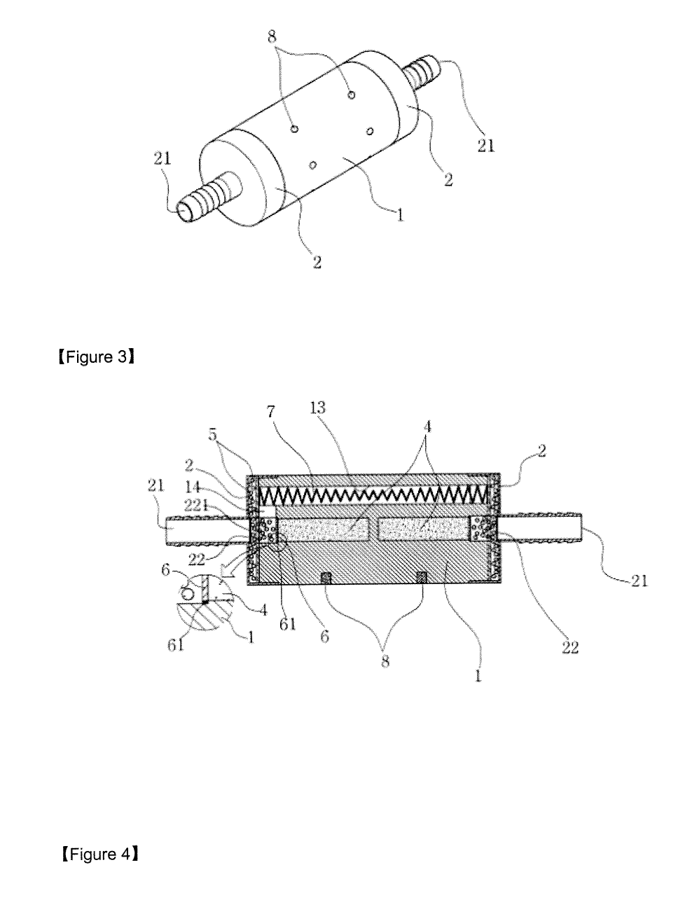

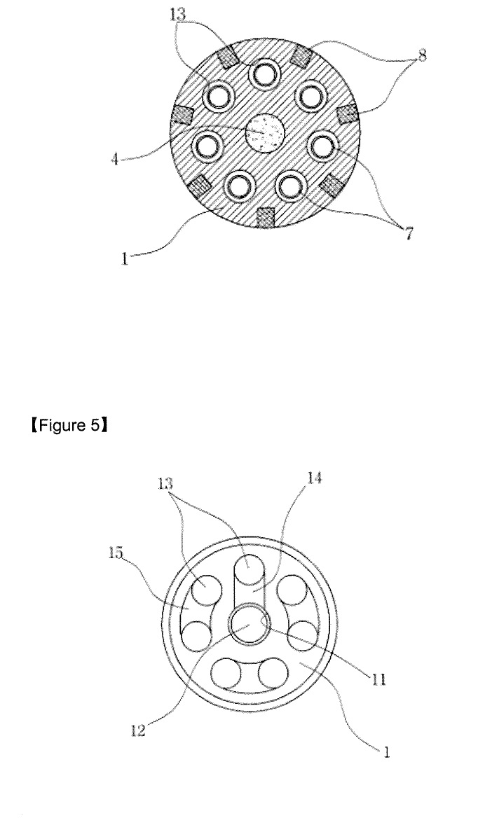

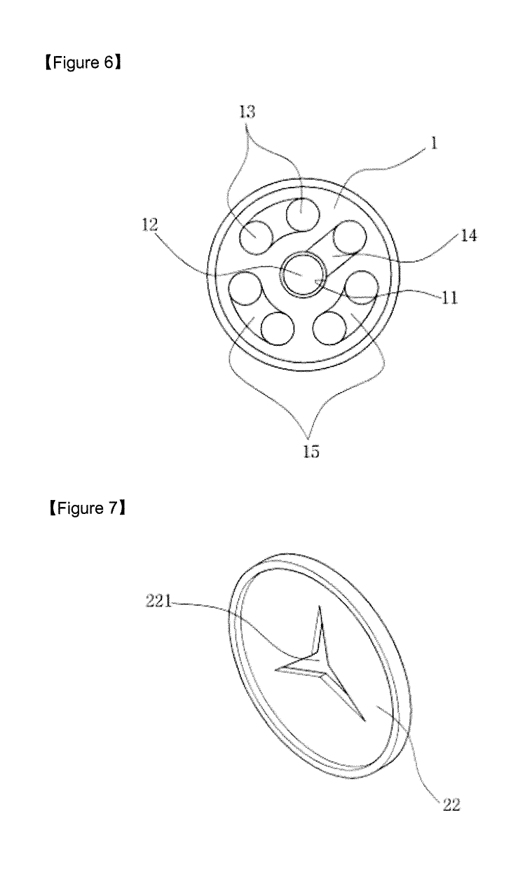

### BEST MODE

A process for preparing ceramic fillers 4 and ceramic balls 5 emitting far-infrared radiation, which serve to perform catalysis with liquid fuel in accordance with the present invention, are described with reference to Example 1 below.

### MODE FOR INVENTION

Ceramic fillers 4 and ceramic balls 5 are prepared by mixing a basic component (A) consisting of 61% by weight of SiO₂, 10.1% by weight of Al₂O₃, 1.2% by weight of Fe₂O₂, 1.98% by weight of CaO₂, 0.5% by weight of MgO₂, 2.5% by weight of K₂O, 3.59% by weight of Na₂O, 1.5% by weight of TiO₂, 0.05% by weight of ZrO₂, 5.8% by weight of Igloss and 4.28% by weight of Se, and

an additional component (B), which is used to obtain more efficient radiation of far-infrared from ceramic components, consisting of 4% by weight of cupric oxide, 6% by weight of ZrO₂, 14% by weight of CaO₂, 7% by weight of TiO₂, 4% by weight of cobalt, 6% by weight of B₂O, 8% by weight of CeO₂, 5% by weight of K₂O₃, 4% by weight of Mo, 5% by weight of SrO₃, 25% by weight of CaO, 4% by weight of MgZn, 5% by weight of NiZn and 3% by weight of Pd.

The ceramic fillers are prepared by mixing 63 to 83% by weight of the basic component (A) and 37 to 17% by weight of the additional component, sintering the mixture at a temperature of 1000 to 1300° C. and milling the resulting materials to a size of 3 to 5 μm, and the ceramic balls are prepared by mixing and sintering 63 to 83% by weight of the basic component (A) and 37 to 17% by weight of the additional component at a temperature of 1000 to 1300° C. and forming the resulting materials into balls.

### INDUSTRIAL APPLICABILITY

As such, the present invention can ionize liquid fuels for use in vehicles, as well as water. Therefore, the present invention may be applied to filter-free water purifiers and water softeners, instant hot water heaters, and heating arrangements.

1. A multi-purpose liquid atomizer, utilizing a catalyst, turbulence, and collision, comprising:
a cylindrical main body 1 having inlet/outlet grooves 11 for flow of liquid fuel and cylindrical ceramic filling grooves 12 containing powdered ceramic fillers 4 packed therein, formed in multiple stages, at the central outer surface of both sides thereof;
circular-shaped magnetic plates 6 for supplying far-infrared radiation and sealing the ceramic fillers 4 formed at the end of the ceramic filling grooves 12,
an uneven number of flow holes 13 radially formed around the ceramic filling grooves 12 so as to penetrate through the main body, inlet/outlet passages 14 communicating between inlet/outlet grooves 11 and different flow holes 13 formed in the main body 1, flow passages 15 communicating two different flow holes 13 formed at both sides of the main body 1, an even number of permanent magnets 8 for reforming liquid fuel, formed in plural rows between flow holes 13 along the outer surface of the main body 1, circular-shaped sealing plates 3 having through holes at the centers thereof, and sealing flow holes 13 and flow passages 15 formed at both sides of the main body 1, and inlet/outlet caps 2 fixing the sealing plates 3 to both sides of the main body 1, containing a multiplicity of ceramic balls 5 catalyzing the liquid fuel formed therein and having a turbulence plate 22 generating turbulence formed on the central inner side.

2. The atomizer according to claim 1 wherein the centrally concave mortar-shaped circular special metal springs 7 are formed within the flow holes 13 to cause turbulence and collision of the liquid fuel.

3. The atomizer according to claim 1, wherein a [symbol] shaped turbulence hole 221 for swirling inflow/outflow of the liquid fuel is formed at the center of the turbulence plate 22.

4. The atomizer according to claim 1, wherein the ceramic fillers 4 and ceramic balls 5 are prepared by mixing 63 to 83% by weight of a basic component (A) consisting of 61 to 68.5% by weight of SiO₂, 10.1 to 13.4% by weight of Al₂O₃, 1.2 to 3.54% by weight of Fe₂O₂, 1.98 to 2.98% by weight of CaO₂, 0.5 to 1.91% by weight of MgO₂, 2.5 to 4.5% by weight of K₂O, 3.59 to 5% by weight of Na₂O, 1.5 to 2.0% by weight of TiO₂, 0.05 to 1% by weight of ZrO₂, 5.8 to 8.0% by weight of Igloss and 4.28 to 5.5% by weight of Se and 37 to 17% by weight of an additional component (B) consisting of 4 to 5% by weight of cupric oxide, 6 to 7% by weight of ZrO₂, 14 to 16% by weight of CaO₂, 7 to 9% by weight of TiO₂, 4 to 7% by weight of cobalt, 6 to 7% by weight of B₂O, 8 to 13% by weight of CeO₂, 5 to 7% by weight of K₂O₃, 4 to 6% by weight of Mo, 5 to 7% by weight of SrO₃, 10 to 25% by weight of CaO, 4 to 5% by weight of MgZn, 5 to 9% by weight of NiZn, and 3 to 5% by weight of Pd, sintering the mixture at a temperature of 1000 to 1300° C. and milling the sintered materials to a size of 3 to 5 μm, or forming them into balls.
